(19) United States
(12) Patent Application Publication
(10) Pub. No.: US 2025/0245132 A1
(43) Pub. Date: Jul. 31, 2025

(54) CODE SUBMISSION AND REVIEW PROCESS EVALUATION SYSTEM AND METHOD

(71) Applicant: Microsoft Technology Licensing, LLC, Redmond, WA (US)

(72) Inventors: Jeffrey Earl STEINBOK, Sammamish, WA (US); Nicola Greene ALFEO, Seatle, WA (US); Derek Andrew PARK, Seatle, WA (US); Randee BIERLEIN, Seatle, WA (US)

(73) Assignee: Microsoft Technology Licensing, LLC, Redmond, WA (US)

(21) Appl. No.: 18/425,161

(22) Filed: Jan. 29, 2024

(51) Int. Cl. G06F 11/36

(52) U.S. Cl. CPC G06F 11/3688

(57) ABSTRACT

A system for evaluating a pull request process for a code repository is configured to access pull request data for a plurality of completed pull requests associated with code stored in a code repository and process the pull request data to identify pull requests with a policy pass/fail characteristic indicative of environmental error. The identified pull requests are then analyzed to determine which infrastructure and/or software component of a code review system is a source of the environmental error and/or a rate of occurrence of the policy pass/fail characteristic in the completed pull requests. An alert is then generated via a user interface of the pull request process evaluation system indicating an environmental error to indicate which infrastructure and/or software component of the code review system is a source of the environmental error and/or the rate of occurrence of the policy pass/fail characteristic in the completed pull requests.

### BACKGROUND

Source code is the foundation of any software development practice, and managing that source code is the first task tackled by modern software development pipelines, with all subsequent stages of the pipeline dependent on the source code for their success and functionality. Thus, it is critical that source code is properly managed without introducing bottlenecks or inefficiencies into the delivery pipeline. One possible source of bottlenecks and inefficiencies is the pull request process. Pull requests are typically performed during code review when a developer submits new or revised code (also referred to as a “commit” or “proposed change”) for merging into the codebase for a software development project. Pull requests typically involve automated testing and policy automation as well as a peer code review process during which other developers can analyze the code and provide comments. Automated checks inherently introduce unreliability and slowness into the overall process.

However, finding ways to evaluate the effectiveness and reliability of code submission and code review processes have been hampered by the inability to determine whether errors and failures are caused by users or caused by the environment (e.g., system infrastructure). Hence, there is a need to find ways to automatically distinguish between user-induced errors and environmental errors so that unreliable system components can be found and addressed in a quick and efficient manner.

### SUMMARY

In one general aspect, the instant disclosure presents a pull request process evaluation system having a processor and a memory in communication with the processor wherein the memory stores executable instructions that, when executed by the processor alone or in combination with other processors, cause the pull request process evaluation system to perform multiple functions. The function may include accessing pull request data for a plurality of completed pull requests associated with code stored in a code repository using a data extraction component; processing the pull request data to identify pull requests with a policy pass/fail characteristic indicative of environmental error; aggregating the pull request data of the identified pull request using a data aggregation process to generate at least one report that expresses the pull request data in a manner that associates at least one hardware or software component of a code review system that processed the pull request with the environment error; and generating an alert via a user interface of the pull request process evaluation system indicating the environmental error and the at least one hardware or software component associated with the environmental error.

In yet another general aspect, the instant disclosure presents a method of evaluating a pull request process of a code review system associated with a code repository. The method includes accessing pull request data for a plurality of completed pull requests associated with code stored in a code repository using a data extraction component; processing the pull request data to identify pull requests with a policy pass/fail characteristic indicative of environmental error; analyzing the identified pull requests to determine a rate at which pull requests have the policy pass/fail characteristic; and generating an alert via a user interface of the pull request process evaluation system when the rate exceeds a predefined threshold value.

In a further general aspect, the instant application describes a non-transitory computer readable medium on which are stored instructions that when executed cause a programmable device to perform functions of accessing pull request data for a plurality of completed pull requests associated with code stored in a code repository using a data extraction component; processing the pull request data to identify pull requests with a policy pass/fail characteristic indicative of environmental error; analyzing the identified pull requests to determine which infrastructure and/or software component of a code review system is a source of the environmental error; and generating an alert via a user interface of a pull request process evaluation system indicating the environmental error and the source of the environmental error.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system upon which aspects of this disclosure may be implemented.

FIG. 2 depicts an example of a job creation and deployment system for the cloud-bases service of FIG. 1.

FIG. 3 depicts a diagram of a job definition defining attributes for a job for use with the job creation and deployment system of FIG. 2.

FIG. 4 depicts a diagram of an example ring configuration for deploying updates on a cloud-based service architecture.

FIG. 5 depicts a flowchart of an example method for creating and deploying jobs for a cloud-based service that utilizes build time validation in accordance with this disclosure.

FIG. 6 depicts a flowchart of another example method creating and deploying jobs for a cloud-based service that utilizes build time validation in accordance with this disclosure.

### DETAILED DESCRIPTION

Version control systems facilitate code management as well as coordination, sharing, and collaboration between members of a software development team. Good code management enables teams to work in distributed and asynchronous environments, manage changes and versions of code and artifacts, and resolve merge conflicts and related anomalies. Source code files and related assets for software development projects are often stored in a source code repository. A version control system enables source code files to be checked out by developers to make changes. The version control system also enables changed source code files to be checked back in, or committed, to the code repository when the changes are completed.

A pull request is typically performed before changed code is allowed to be committed to the repository. A pull request process is initiated when a developer submits a pull request which identifies and describes the change to the code. Pull requests typically involve automated testing and policy automation as well as a peer code review process during which other developers can analyze the code and provide comments. The review is performed to find errors, evaluate the code for vulnerabilities, such as race conditions, malware, memory leaks, buffer overflows, format string exploits, etc., and to ensure that the code conforms to any applicable coding standards, practices, policies, and the like. While effective, automated checks inherently introduce unreliability and slowness into the overall process. However, finding ways to evaluate the effectiveness and reliability of code submission and pull request processes so that these processes can be improved has been difficult. One of the main obstacles to overcome is the inability to distinguish between user-induced errors and errors and inefficiencies caused by the environment (e.g., the system infrastructure).

To address these technical problems and more, in an example, this description provides technical solutions for evaluating code submission and pull request processes that is capable of distinguishing user-induced errors and environmental errors based on metrics derived from the pull request data for completed pull requests. As an example, pull request data from completed pull requests is analyzed to identify policy pass/fail characteristics indicative of environment errors (e.g., errors caused by hardware or software components of the review system). An example of such a policy pass/fail characteristic is a pull request having an iteration during which a policy failed and then was subsequently retried. This occurrence can be indicative of a faulty or incorrectly configured test, especially in situations where there was no modification of the pull request after the previous commit or iteration. In various implementations, only the last commit or iteration for a pull request is analyzed because this is the commit that is most likely to not have required a modification of code or policy from the previous iteration. The data from the identified pull requests is then aggregated into reports which can be used to identify unreliable and/or failing system components, such as repositories, pipelines, testing components, etc. The data can also be used as the basis to establish rules for evaluating system performance and triggering automatic alerts when performance drops below a threshold, thereby enabling system problems to be quickly identified and mitigated.

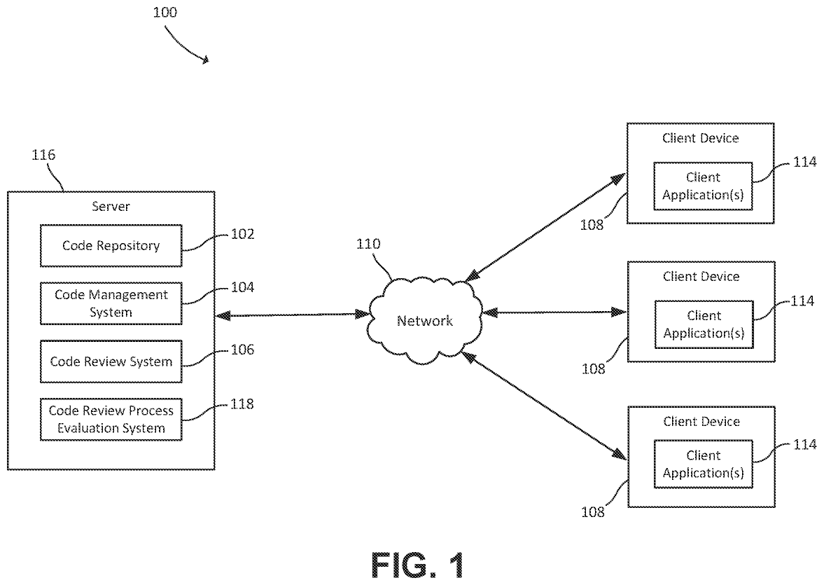

FIG. 1 shows an example implementation of a software development environment 100 in which aspects of the disclosure may be implemented. The software development environment 100 includes a code repository 102, a code management system 104, a code review system 106, and client devices 108 which are interconnected over a computer network 110. The computer network 110 may include various types of communication networks, such as a wide area network (WAN), local area network (LAN), a telecommunication network, a wireless network, a public switched network and/or a satellite network, and may include connections, such as wire, wireless communication links, or fiber optic cables. In general, computer network 110 can be any combination of connections and protocols that will support communications in accordance with the implementations described herein.

The code repository 102 stores source code files and related digital assets, such as documentation, configuration files, libraries, and the like, for one or more software development projects. The code management system 104 controls access to the source code files and digital assets in the code repository 102. The code management system 104 also provides version control of source code and assets by tracking and maintaining a record of every change made to every file and asset in the repository 102. In some implementations, the record of changes made to the files and assets is stored in the code repository 102, e.g., as metadata. In other implementations, the record of changes is stored in a data store or storage location that is separate from the code repository 102. The code management system 104 may be programmed to implement any suitable type of version control, including central and distributed.

The code management system 104 provides mechanisms For example, the code management system 104 may provide mechanisms for branching and merging code changes within the repository. A branch is a separate line of development that diverges from the main line (often called the “master” or “main” branch) of a codebase. Branches provide isolation, allowing developers to make changes to the codebase without impacting the main branch. Merging refers to the process of integrating code changes from a branch back into the main branch, or trunk, of the codebase.

Code repository 102 and code management system 104 are implemented on one or more servers, such as server 116, which are configured to provide computational and storage resources for the code management system 104 and the code repository 102. Servers may have access to one or more data stores (not shown) which store data, programs, and the like for implementing the code repository 102 and code management system 104. Although a single server 116 is shown in FIG. 1, any suitable number of servers (and data stores) may be used to implement the code repository 102 and code management system 104.

Client devices 108 enable users (e.g., developers) to access and interact with the code repository 102 and code management system 104, e.g., by checking out code and by committing revised code to the repository 102. To this end, client devices 108 include one or more software development client applications 114 configured to interact with the code management system 104, e.g., by checking out files and/or creating branches in the code repository 102. In some implementations, client applications 114 include code editing applications, integrated development environment applications, code testing applications, or the like which have the functionality for interacting with the code repository 102 and code management system 104 built-into the application. In other implementations, the functionality for interacting with the repository 102 and code management system 104 is implemented by an add-on or plug-in. In some implementations, client applications include general purpose applications, such as web browsers, which enable access to the code repository 102 and code management system 104 via one or more web applications. In various implementations, each client device 108 may be, for example, a laptop computer, a tablet computer, netbook computer, personal computer (PC), a desktop computer, a personal digital assistant (PDA), a smart phone, or any type of computing device capable of running a program, accessing a network, and displaying user interfaces used for interacting with the code repository 102 and code management system 104.

Before code updates are committed or merged to the repository 102, a pull request process is performed to discover errors and to ensure that the code conforms to any applicable coding standards, practices, policies, and the like. The pull request process includes an automated analysis and testing phase during which one or more code inspecting and/or testing tools are utilized to analyze/inspect the code to find syntax errors, coding errors, misspellings, and the like by checking the code against predefined rules, conventions, and best practices. Testing may also include evaluating the code for vulnerabilities, such as race conditions, malware, memory leaks, buffer overflows, format string exploits, and the like. The pull request process also includes an automated policy compliance phase during which an automated policy compliance check is performed to determine whether the code update has satisfied all policies which may be applicable to the code update. Policies may define, for example, the types of tests, the number of iterations of each test, the number of tests passed, and the like. The pull request process also includes a manual review phase during which the proposed code update is reviewed by one or more peers of the developer of the code update. This phase is typically performed to find bugs that may have been missed and to evaluate the code update to determine whether it complies with organizational standards and/or best practices, whether adequate testing has been performed, etc. Reviewers provide comments for the developer based on the review and/or can reject the update evaluation reveals any inadequacies.

The code review system 106 provides mechanisms for managing and facilitating the pull request process. The pull request process is initiated by submitting a formal pull request to the code review system 106. In various implementations, the client device 108 includes a client application 114 that enables pull requests to be generated and submitted to the code review system 106. The pull request includes a comment section, a title, a description, and/or the before-code and the after-code. In the description, the changes made to the code are described. In the comment section, reviewers can add comments regarding the proposed change. A pull request is composed of one or more commits. A commit is an individual change to a file or set of files in the code repository 102.

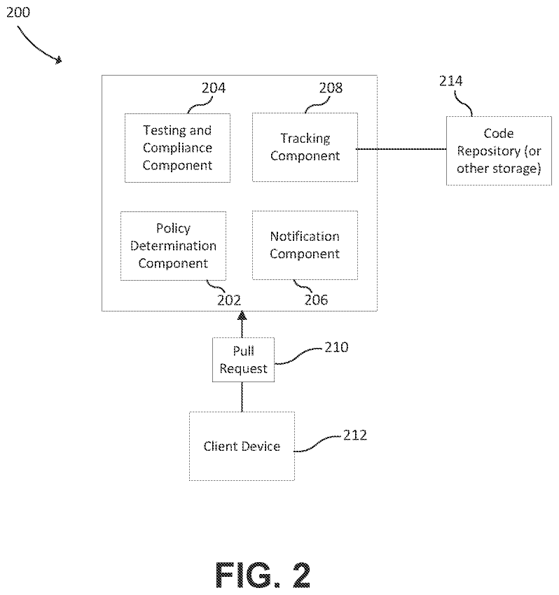

An example implementation of a code review system 200 is shown in FIG. 2. The code review system 200 includes a policy determination component 202, an automated testing and compliance component 204, a notification component 206, and a tracking component 208. The policy determination component is configured to process a pull request 210 (e.g., from client device 212) to determine the policies which are applicable to the pull request 210. The policies in turn define the testing to be performed. Once the required testing has been identified, the code update is provided to the automated testing and compliance component 204 which is configured to perform the testing required by the applicable policies. The notification component 206 is configured to publish the pull request via the code management system 104 so that all developers with appropriate access can view the pull request. The notification component 206 also notifies one or more developers that they are tasked to perform the manual review for the pull request. The tracking component 208 is configured to track and collect pull request data, such as start times and end times for each phase, outcomes of testing, policy successes and failures, number of iterations performed, number of commits performed, number of requeues performed, etc., and store the pull request data for each pull request in the code repository and/or in a separate data store. Once a pull request has been completed, e.g., the last commit of the pull request has passed and the manual review process has indicated that the pull request should be merged, the code update is merged into the code repository and the completed pull request is stored in the code repository 214 and/or in another suitable storage location.

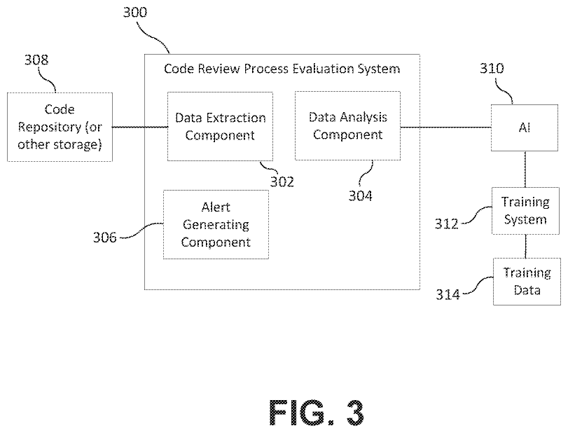

As noted above, measuring the effectiveness and reliability of code submission processes is challenging because previously known systems have not found a reasonable way of distinguishing sources of errors and failures in code submission and review processes. The present disclosure provides a pull request process evaluation system 118 (FIG. 1) capable of distinguishing between user-induced errors and environmental errors based on metrics derived from the pull request data for completed pull requests. An example implementation of a pull request process evaluation system 300 is shown in FIG. 3. The system 300 includes a data extraction component 302, a data analysis component 304, and an alert generating component 306. The data extraction component 302 is configured to access completed pull requests and pull request data from the code repository or other storage 308. The data analysis component 304 is configured to analyze the completed pull request data to identify pull requests having one or more predetermined characteristics which are indicative of problems caused by the code submission and review infrastructure (i.e., the environment), rather than user-induced error.

As an example, in various implementations, the pull request data from completed pull requests is analyzed to identify pull requests that have, during the last commit of the request, any policies that initially failed (e.g., the code update initially did not comply with one or more policies associated with the last commit), were retried, and then succeeded. The data from the identified pull requests is then aggregated and reported in a manner that enables distinctions to be made as to the source of errors and inefficiencies in the code submission and review process. For example, in various implementations, the aggregation process includes analyzing the pull request data from the identified pull requests to determine whether the last commit in each pull request involved a change to the pull request, such as a change to the code or a policy change. A code test that gives both passing and failing results without a change to the code or the test is referred to as a “flaky” test. Flaky tests results indicate a problem with the test, which is an environmental source of errors for the system. A percentage of pull requests having policy failures and policy successes in the same iteration is then determined which can be used as a measure of the magnitude of testing problem. For example, one or more threshold percentages may be defined for indicating different levels of testing failures for the system. When the percentage of pull requests having flaky test results exceeds a threshold percentage value, the alert generating component is configured to generate an alert via a user interface indicating a possible problem with the testing component of the system.

In other implementations, the system evaluates all commits/iterations of each completed pull request to identify pull requests having iterations that involve failures and retries (also referred to as requeues) without a change to the pull request. The overall percentage of iterations having flaky test results can then be identified. One or more threshold percentages for the percentage of iterations having flaky test results may be defined for indicating different levels of testing failures for the system. In some implementations, the number of pull requests having multiple iterations with flaky test results is identified and used as an indicator of environmental failures. The last commit of a pull request is the most likely commit that does not have code or policy changes which makes it a good source to evaluate for flaky tests. It also requires less computer resources and network bandwidth than would be required for analyzing all iterations of each completed pull request. However, analyzing all iterations of all completed pull requests would provide more data points for determining whether there are problems with the system.

In various implementations, the data analysis component 304 utilizes artificial intelligence (AI) 310 to process pull requests and pull request data to identify pull requests where the last iteration (or any iteration in some implementations) does not have a change to the pull request, such as a code or policy change. In various implementations, the AI 310 is a generative language model, such as a Large Language Model (LLM). Examples of LLMs include, but are not limited to, generative models, such as Generative Pre-trained Transformer (GPT)-based models, e.g., GPT-3, GPT-4, ChatGPT, and the like. In other embodiments, any suitable type and number of language learning/processing model may be utilized. The AI 310 receives a pull request as input (e.g., a prompt) and is trained to process the pull request to determine whether the pull request has policy pass/fail characteristics indicative of one or more environmental errors, such as iterations that do not have a pull request change relative to the previous iteration and that have a last iteration (or any iteration) during which a policy failed and was then retried and passed. The AI provides an output indicating the result of the processing, e.g., the pull request does or does not have the policy pass/fail characteristics.

A training system 312 trains the AI 310 to process pull requests (and associated test data) to generate outputs as described above. In various embodiments, a training system 312 is used to train the AI 310 using training data 314 to provide initial and ongoing training AI 310 to maintain and/or adjust performance. The training data 314 includes pull requests having desired characteristics, such as a last iteration (or any iteration) that does not involve a pull request change. Training data 314 may also include pull request data and test data for pull requests that have a last iteration (or any iteration) having a policy failure that has been retried and been successful.

In some implementations, the data analysis component 304 is configured to analyze the pull request data and test data to determine system infrastructure components (e.g., repositories, pipelines, etc.) and/or software components (e.g., testing, policy automation, etc.) associated with identified environmental errors. In various embodiments, when system infrastructure and/or software components associated with an environmental error have been identified, the alert generating component 306 can generate an alert or notification via a user interface of the pull request evaluation system, such as a user interface on a client device. This in turn enables unreliable infrastructure components and software components to be identified and tagged for further investigation and/or immediate mitigation procedures.

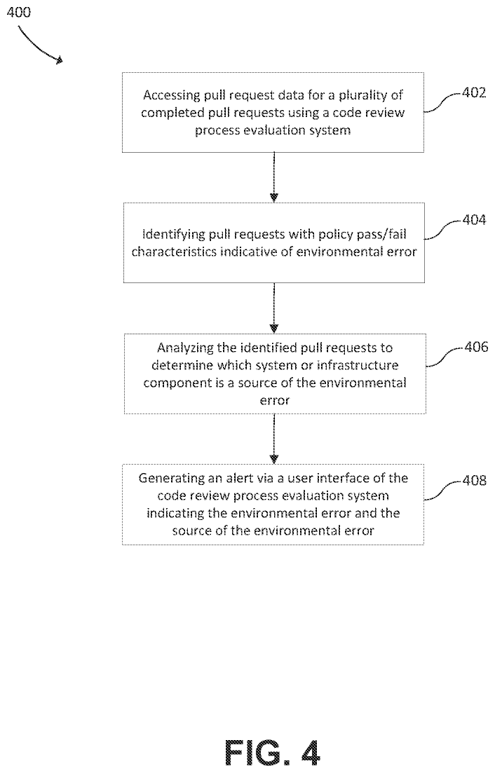

A flowchart of an example method 400 of evaluating a code submission and review process for a code management system is shown in FIG. 4. The method begins with accessing pull request data for a plurality of completed pull requests using a pull request process evaluation system (block 402). The system processes the pull requests to identify pull requests with policy pass/fail characteristics indicative of environmental error (block 404). The identified pull requests are then analyzed by a data analysis component of the pull request process evaluation system to determine which system or infrastructure component is a source of the environmental error (block 406). An alert is then generated via a user interface of the pull request process evaluation system indicating the environmental error and the source of the environmental error (block 408).

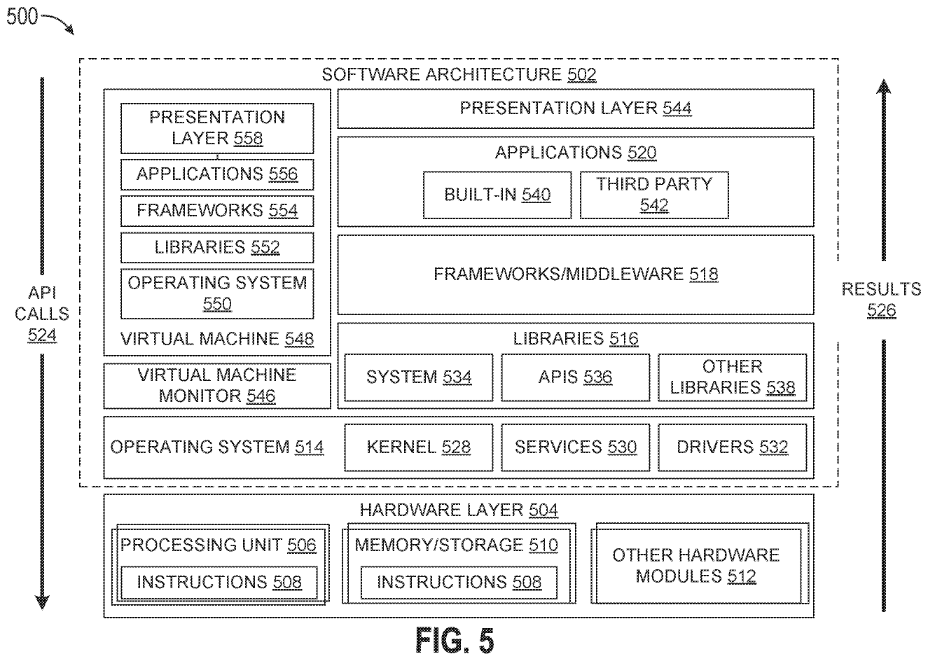

FIG. 5 is a block diagram 500 illustrating an example software architecture 502, various portions of which may be used in conjunction with various hardware architectures herein described, which may implement any of the above-described features. FIG. 5 is a non-limiting example of a software architecture and it will be appreciated that many other architectures may be implemented to facilitate the functionality described herein. The software architecture 502 may execute on hardware such as client devices, native application provider, web servers, server clusters, external services, and other servers. A representative hardware layer 504 includes a processing unit 506 and associated executable instructions 508. The executable instructions 508 represent executable instructions of the software architecture 502, including implementation of the methods, modules and so forth described herein.

The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular system. The applications 520 may use functions available via OS 514, libraries 516, frameworks 518, and presentation layer 544 to create user interfaces to interact with users.

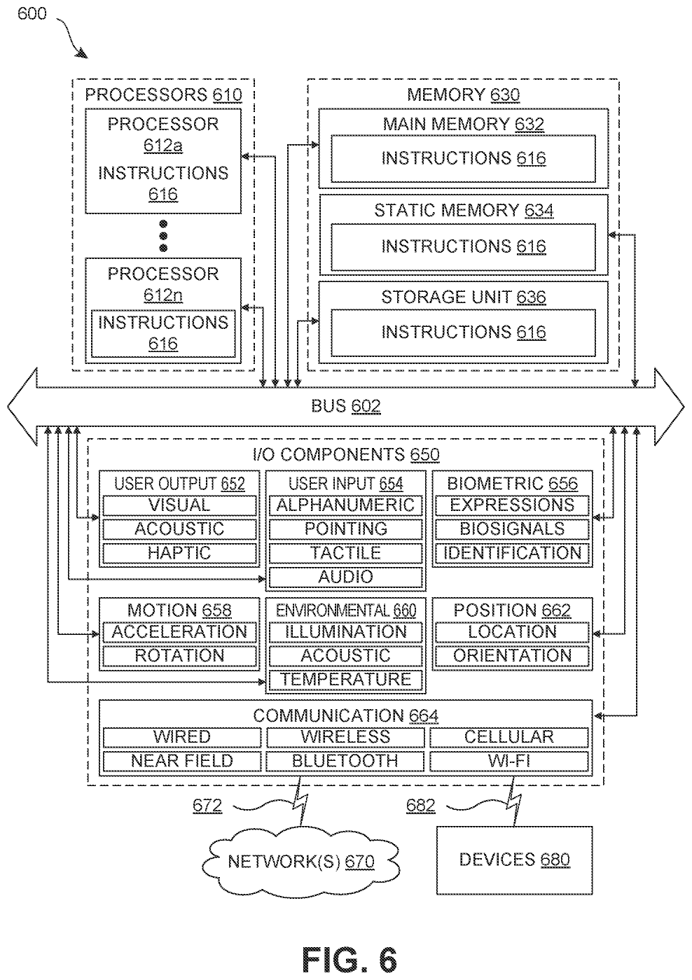

Some software architectures use virtual machines, as illustrated by a virtual machine 548. The virtual machine 548 provides an execution environment where applications/modules can execute as if they were executing on a hardware machine (such as the machine depicted in block diagram 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement methods or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660 and/or position components 662, among a wide array of other environmental sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 662 may include, for example, location sensors (for example, a Global Position System (GPS) receiver), altitude sensors (for example, an air pressure sensor from which altitude may be derived), and/or orientation sensors (for example, magnetometers). The motion components 658 may include, for example, motion sensors such as acceleration and rotation sensors. The environmental components 660 may include, for example, illumination sensors, acoustic sensors and/or temperature sensors.

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A pull request process evaluation system comprising:
a processor; and
a memory in communication with the processor, the memory comprising executable instructions that, when executed by the processor alone or in combination with other processors, cause the pull request process evaluation system to perform functions of:
accessing pull request data for a plurality of completed pull requests associated with code stored in a code repository using a data extraction component;
processing the pull request data to identify pull requests with a policy pass/fail characteristic indicative of environmental error;
aggregating the pull request data of the identified pull request using a data aggregation process to generate at least one report that expresses the pull request data in a manner that associates at least one hardware or software component of a code review system that processed the pull request with the environment error; and
generating an alert via a user interface of the pull request process evaluation system indicating the environmental error and the at least one hardware or software component associated with the environmental error.

2. The pull request process evaluation system of claim 1, wherein the policy pass/fail characteristic is a commit with no code or policy changes relative to a previous commit during which a policy failed and was subsequently retried and passed.

3. The pull request process evaluation system of claim 2, wherein the functions further comprise:
determining a quantity of the identified pull requests having the policy pass/fail characteristic; and
correlating the quantity to a measure of a magnitude of the environmental error in the pull request system.

4. The pull request process evaluation system of claim 3, wherein correlating the quantity to the measure of the magnitude of the environmental error further comprises:
determining a percentage of the identified pull request having the policy pass/fail characteristic; and
comparing the percentage to at least one predefined threshold percentage value to determine the magnitude of the environmental error.

5. The pull request process evaluation system of claim 1, wherein processing the pull request data to identify the pull requests with the policy pass/fail characteristic indicative of the environmental error further comprises:
providing the pull request data to an artificial intelligence (AI) model trained to process the pull request data and provide an output indicating whether a pull request has the policy pass/fail characteristics.

6. The pull request process evaluation system of claim 1, wherein the AI model is trained to analyze the identified pull requests to determine the infrastructure and/or the software component of the code review system that is the source of the environmental error.

7. The pull request process evaluation system of claim 1, wherein the code review system is configured to manage a pull request process, the pull request process includes an automated testing and policy compliance phase and a peer review phase, and
wherein the pass/fail characteristic is caused during the automated testing and policy compliance phase.

8. The pull request process evaluation system of claim 1, further comprising:
continuing to process the pull request data as pull requests are completed to identify the pull requests with the policy pass/fail characteristic;
monitoring a rate at which pull requests having the policy pass/fail characteristic; and
generating the alert when the rate exceeds a predetermined threshold value.

9. A method of evaluating a pull request process of a code review system associated with a code repository, the method comprising:
accessing pull request data for a plurality of completed pull requests associated with code stored in a code repository using a data extraction component;
processing the pull request data to identify pull requests with a policy pass/fail characteristic indicative of environmental error;
analyzing the identified pull requests to determine a rate at which pull requests have the policy pass/fail characteristic; and
generating an alert via a user interface of the pull request process evaluation system when the rate exceeds a predefined threshold value.

10. The method of claim 9, wherein the policy pass/fail characteristic is a commit with no code or policy changes relative to a previous commit during which a policy failed and was subsequently retried and passed.

11. The method of claim 10, wherein the policy pass/fail characteristic is indicative of a flaky test.

12. The method of claim 9, wherein processing the pull request data to identify the pull requests with the policy pass/fail characteristic indicative of the environmental error further comprises:
providing the pull request data to an artificial intelligence (AI) model trained to process the pull request data and provide an output indicating whether a pull request has the policy pass/fail characteristics.

13. The method of claim 12, wherein the AI model is trained to analyze the identified pull requests to determine an infrastructure and/or a software component of the code review system that is a source of the environmental error.

14. The pull request process evaluation system of claim 9, wherein the code review system is configured to manage the pull request process, the pull request process includes an automated testing and policy compliance phase and a peer review phase, and
wherein the pass/fail characteristic is caused during the automated testing and policy compliance phase.

15. A non-transitory computer readable medium on which are stored instructions that, when executed, cause a programmable device to perform functions of:
accessing pull request data for a plurality of completed pull requests associated with code stored in a code repository using a data extraction component;
processing the pull request data to identify pull requests with a policy pass/fail characteristic indicative of environmental error;
analyzing the identified pull requests to determine which infrastructure and/or software component of a code review system is a source of the environmental error; and
generating an alert via a user interface of a pull request process evaluation system indicating the environmental error and the source of the environmental error.

16. The non-transitory computer readable medium of claim 15, wherein the policy pass/fail characteristic is a commit with no code or policy changes relative to a previous commit during which a policy failed and was subsequently retried and passed.

17. The non-transitory computer readable medium of claim 16, wherein the functions further comprise:
determining a quantity of the identified pull requests having the policy pass/fail characteristic; and
correlating the quantity to a measure of a magnitude of the environmental error in the code review system.

18. The non-transitory computer readable medium of claim 17, wherein correlating the quantity to the measure of the magnitude of the environmental error further comprises:
determining a percentage of the identified pull request having the policy pass/fail characteristic; and
comparing the percentage to at least one predefined threshold percentage value to determine the magnitude of the environmental error.

19. The non-transitory computer readable medium of claim 15, wherein processing the pull request data to identify the pull requests with the policy pass/fail characteristic indicative of the environmental error further comprises:
providing the pull request data to an artificial intelligence (AI) model trained to process the pull request data and provide an output indicating whether a pull request has the policy pass/fail characteristics.

20. The non-transitory computer readable medium of claim 15, wherein the AI model is trained to analyze the identified pull requests to determine the infrastructure and/or the software component of the code review system that is the source of the environmental error.
